(19) United States
(12) Patent Application Publication
(10) Pub. No.: US 2016/0009581 A1
(43) Pub. Date: Jan. 14, 2016

(54) Water Treatment Facility

(71) Applicant: Malcolm Bruce GORDON, Ringwood (AU)

(72) Inventor: Malcolm Bruce GORDON, Ringwood (AU)

(21) Appl. No.: 14/769,107

(22) PCT Filed: Feb. 21, 2014
(86) PCT No.: PCT/AU2014/000157

§ 371 Date: Aug. 20, 2015

(30) Foreign Application Priority Data
Feb. 22, 2013 (AU) 2013900598

(51) Int. Cl. C02F 9/00; C02F 1/78; C02F 1/32; C02F 1/00; C02F 1/40

(52) U.S. Cl. CPC C02F 9/00; C02F 1/004; C02F 1/40; C02F 1/32; C02F 1/78; C02F 2209/40

(57) ABSTRACT

A water treatment facility for treating raw water and delivering the treated water to a plumbing network. The flow rate is measured by a flow meter. The raw water is passed through a pre-filter and is then temporarily stored in a first tank. The water level in the first tank is kept within a desired maximum and minimum level. The water from the first tank is delivered to a plurality of filter modifies. The plurality of filter modules are arranged so that the flow can be configured to flow through all the filter modules simultaneously, or any one or more filter modules exclusively. The flow path through the filter module(s) can be arranged to flow either sequentially or in parallel. A disinfectant system is included that is capable of producing and delivering a disinfectant agent into the outflow on an as needed basis.

### FIELD OF THE INVENTION

This invention relates to raw water treatment facilities that include both autonomous operational control means, with a centralised monitoring and control facility that is capable of monitoring and controlling a plurality of geographically dispersed water treatment facilities.

### BACKGROUND OF THE INVENTION

Potable drinking water is a critical resource. Many remote communities, or remote dwellings, or facilities such as mine sites, require a reliable source of potable water. Providing this resource in many remote locations is often very difficult and costly. Often supplies of potable water need to be shipped to the site, and constantly replenished as the potable water supply is consumed.

Many autonomous raw water treatment systems have been developed in the past, but they all suffer from the problem that the quality of the treated water output from the system needs to be constantly monitored. The operators of the treatment system typically only become aware of a failure of the overall treatment system once the quality of the water outflowing from the facility fails to meet the required specifications that have been set for the facility. This is reactive rather than predictive, and increases the potential that the water treatment system may not always be operating at its peak effectiveness to treat the particular properties of the water treatment facility's raw water feed.

The present invention attempts to mitigate the above mentioned problems by providing an autonomous controlling system for each water treatment system that is centrally monitored. The autonomous controlling system is capable of being overridden if/when it is deemed necessary to do so. In addition, the present invention utilizes a set of acceptable operating parameters for each critical component in the system, and is able to use that data to initiate mitigating operations on any or all of the critical components in the facility, and the data collected from the operation of the system is capable of being used to create a predictive maintenance, schedule for each particular water treatment system.

### DISCLOSURE OF THE INVENTION

Accordingly, the present invention is a water treatment facility for treating raw water and delivering the treated water to a plumbing network, or at least one storage tank, the system including:
logic control means,
inlet flow control means,
an inlet,
at least one flow meter,
a pre-filter,
a first tank,
first tank outflow control means,
a plurality of filter modules,
a plurality of sensors,
a disinfectant system,
outflow control means,
an outlet,
   wherein the rate of flow of raw water into the facility is controlled by the inlet flow control means under the control of the logic control means. The flow rate is measured by the flow meter and the flow rate data is fed back to the logic control means. The raw water is then passed through the pre-filter and is then temporarily stored in the first tank that acts as a buffer tank. Sensors within the first tank feedback data via the logic control means to the inlet flow control means, so that the water level in the first tank is kept within a desired maximum and minimum level. The water from the first tank is then delivered to the plurality of filter modules via the first tank outflow control means, under the control of the logic control means. The plurality of filter modules are arranged so that the flow can be configured to flow through all the filter modules simultaneously, or any one or more filter modules exclusively, and the flow path through the filter module(s) can be arranged to flow through the filter modules either sequentially or in parallel, all under the control of the logic control means. A controlled outflow from the plurality of filter modules under the control of the logic control means via the outflow control means, flows out of the system through the outlet into the plumbing system that the water treatment facility is providing treated water into a plumbing network, such as that found in a dwelling, or at least one storage tank. The disinfectant system is capable of producing and delivering a disinfectant agent into the outflow, either within the system, or into the pipework that connects the system to the plumbing network, or the storage tank(s) that is connected to the outlet of the water treatment system on an as needed basis, under the control of the logic control means.

In another preferred embodiment, a second tank is provided after the filter modules and before the outlet. When the system is in this configuration, the disinfectant agent is preferably delivered into the second tank, or into the outflow from the filter module(s). The second tank acts as a temporary holding tank so that the water outflow from the filter module(s) is held long enough to enable the disinfectant agent to be effective, and after the water in the second tank has been subject to the disinfectant agent for a sufficient period of time, then a controlled outflow of water, via the logic control means through the outflow control means, is passed out of the system and into the plumbing network, or into at least one storage tank, via the outlet.

Preferably the inlet flow control means includes either a flow control valve, or a fixed orifice plate, or a pump, or a combination of any two or more.

Preferably the logic control means can vary the flow rate through an individual filter module in the plurality of filter modules.

Preferably each filter module has sensor means that feedback to the logic control means. If any module is sensed by the sensor means as operating outside acceptable operating parameters, the logic control means can take that filter module out of service and allow the facility to keep operating by using the remaining filter modules, even if the water treatment facility is required to operate with a reduced capacity

Preferably the logic control means can arrange the flow path through each filter module independently, or in any combination of filter modules, via a backwash feed from the second tank, so that treated water is used to forward flush, or backwash a filter module(s) as required.

Preferably the pre-filter includes a porous belt that is continuously rotated around at least one roller as the flow of water flows laterally through the belt, and the porous belt provides the filter medium.

Preferably the speed that the belt is rotated is controlled by the logic control means, and sensor means are included that measure and control the speed of the belt's rotation.

Preferably a backwash facility is provided to the pre-filter to clean the belt, and periodic backwashing of the belt is undertaken under the control of the logic control means on an “as required” basis.

Preferably ultrasonic vibration means are included to clean the belt, and the ultrasonic means is controlled by the logic control means, and initiated periodically on an “as required” basis.

Preferably the pre-filter includes disinfectant means to inhibit biological growth.

Preferably any waste accumulated from the belt cleaning is collected within the filter housing away from the belt, and is periodically removed.

Preferably the pre-filter includes overflow means.

Preferably the first tank is provided with a facility that periodically flush away the accumulated waste that collects in the bottom of the tank via the logic control means, and the time period between flushing is sufficient to ensure that the tank is operated in a healthy and safe manner.

Preferably the first tank provides the supply of water to the backwash facility for the pre-filter.

Preferably the second tank provides a supply of water to backwash, or forward flush, any or all of the filter modules in the system, and the second tank maintains a minimum water level that correlates to a sufficient volume of water within the second tank to allow for the adequate backwashing or forward flushing of any or all of the filter modules under the control of the logic control means as required. If no second tank is included in the water treatment system, an external supply of suitable water is provided to provide sufficient water to backwash or forward flush the filter modules.

Preferably the disinfectant agent used by the disinfectant means is gaseous and/or ultra-violet radiation.

Preferably the water treatment facility includes means to generate the gaseous disinfectant agent when required by the disinfectant means under the control of the logic control means.

Preferably the gaseous agent generated is ozone.

In another form of the invention, the present invention also provides a central monitoring system for at least one water treatment facility as previously described. The water treatment facility is network enabled, and a feedback stream of water treatment system operating condition data relating to each facility is fed back to the central monitoring system. The central monitoring system includes means to optionally send control instructions back to the logic control means so that the operational parameters of each facility can be remotely controlled.

Preferably the water treatment facilities may be geographically dispersed over a wide area, and the central monitoring system can be a significant distance from some or all of the water treatment facilities that it monitors and controls.

Preferably each water treatment facility has an acceptable set of operating parameters that are optimised for the specific ambient conditions related to each water treatment system's specific location, including the condition of the raw water feed specific to a particular facility's location. At the extremes of this set of parameters are a set of critical control points, and if the sensors detect that that the performance of the overall water treatment system, and/or any specific critical component of the water treatment system, is approaching a critical control point, the logic control means can attempt to autonomously correct the situation by adjusting flow rates through components of the system, and/or changing flow paths, and/or initiating back washing, forward flushing or ultra-sonic cleaning operations, as required, to attempt to keep the system operating within allowable parameters.

Preferably the operating parameters of each water treatment system is also sent to the central monitoring location, creating an alert if/when any parameter approaches a critical control point, and either automatically generated and/or manual corrective instructions may then be sent back to the particular water treatment facility to attempt to correct the situation remotely.

Preferably if an operational parameter of water treatment facility continues to trend towards a critical control point, and neither the autonomous corrective actions of the logic control means, or the corrective instructions sent from the central monitoring location are able to rectify the situation, then the facility can be remotely deactivated and an alert issued to have the water treatment facility serviced.

Preferably the central monitoring facility is able to use statistical analysis to determine the mean time between failure for the various components within the water treatment facility operating at a specific location, and to use that information in conjunction with other analysis techniques to create a service/maintenance schedule specific to each water treatment facility.

### BRIEF DESCRIPTION OF THE DRAWINGS

FIG. 1 is a schematic diagram of the water treatment facility of the present invention.

FIG. 2 is a schematic diagram of an alternative embodiment of the water treatment facility of the preferred embodiment.

### DETAILED DESCRIPTION OF THE PREFERRED EMBODIMENTS

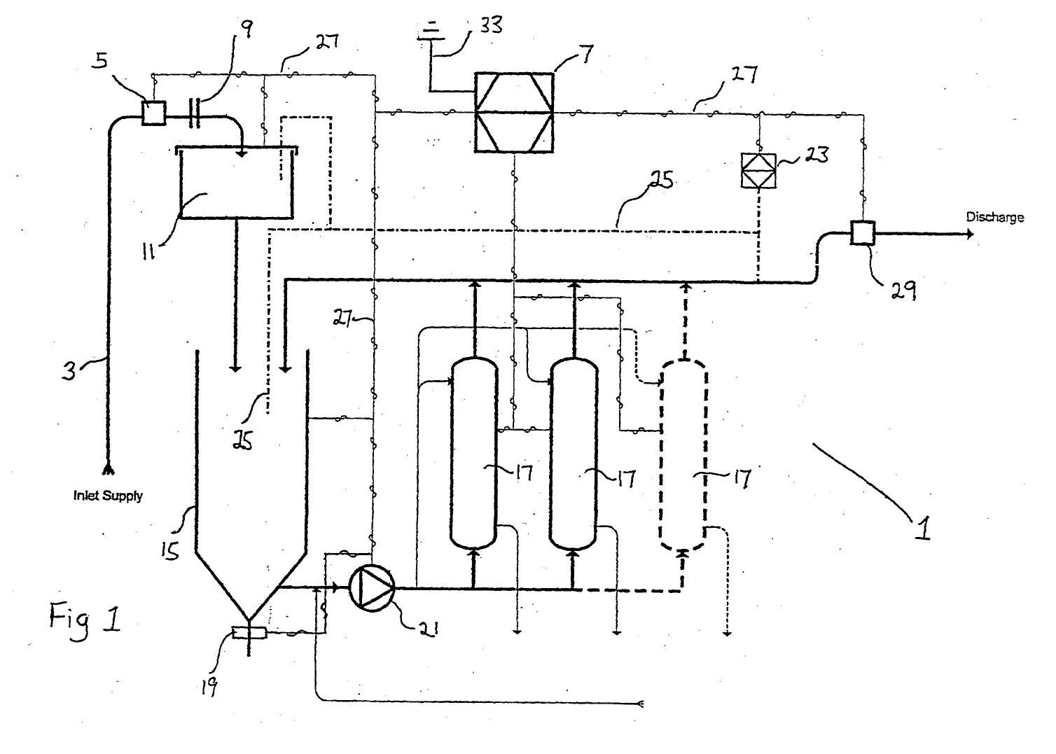

Turning firstly to FIG. 1, we are shown a schematic diagram of a preferred embodiment of the present invention. The water treatment facility 1 receives raw water through the inlet supply line 3. The rate of flow into the facility is controlled by the inlet flow control means 5. The inlet flow control means, like many other components of the system, are controlled by the logic control means 7. Optionally there is an orifice plate 9 located after the inlet flow control means 5. The raw water flows into the pre-filter 11.

The pre-filter 11 includes a rotating belt 13 that is configured so that the flow of incoming raw water impacts the belt laterally. The belt is constructed of a suitably durable and porous material, and thereby acts as the filter medium. The rate at which the rotating belt 13 rotates is monitored and controlled by the logic control means 7.

After pre-filtration, the water then flows into the first tank 15 which acts as a buffer for the plurality of filter modules 17. The bottom of the tank is shaped so that fine solids and biological material can collect in the bottom of the tank so that it can be periodically flushed out via the first tank flushing means 19 under the control of the logic control means 7.

A pump 21, under the control of the logic control means 7 is used to draw water out of the first tank 15 and feed it to the plurality of filter modules 17. The logic control means 7 is able to adjust the number of filter modules 17 that are in use at any one time, and can also arrange the flow path through the filters so that they filter in series, or in parallel via a plurality of control valves (not shown).

A disinfectant system 23 is included to inhibit the growth if biological agents throughout the system. The disinfectant system is capable of generating a gaseous disinfectant agent which is then delivered into key components of the system as shown by line 25. A suitable gaseous disinfectant agent would be ozone. The disinfectant system 23 is capable of generating a suitable quantity of gaseous ozone from the ambient air. Another option would be to use UV radiation as the disinfectant medium. The disinfectant agent is introduced into the pre-filter, the first tank and into the outflow pipework from the filter modules.

The logic control means utilizes a logic control means signal and control network 27 to monitor and control the operation of various critical components within the system.

The treated water is then delivered to the plumbing network or storage tank(s) via the outlet flow control means 29.

To keep the system operating within acceptable performance parameters, a plurality of autonomous self-correction capabilities are programed into the logic control means. These allow for the periodic backwashing and flushing of the pre-filter means 11, the flushing of the collected solids in the bottom of the first tank 15 via the tank flushing means 19. The logic control means 7 is capable of arranging for the water in the first tank 15 to provide the source of backwash and flushing water for the pre-filter 11.

Sensor means are included in the first tank to ensure that a minimum level of water is available for the backwashing and flushing of the pre-filter 11 when required.

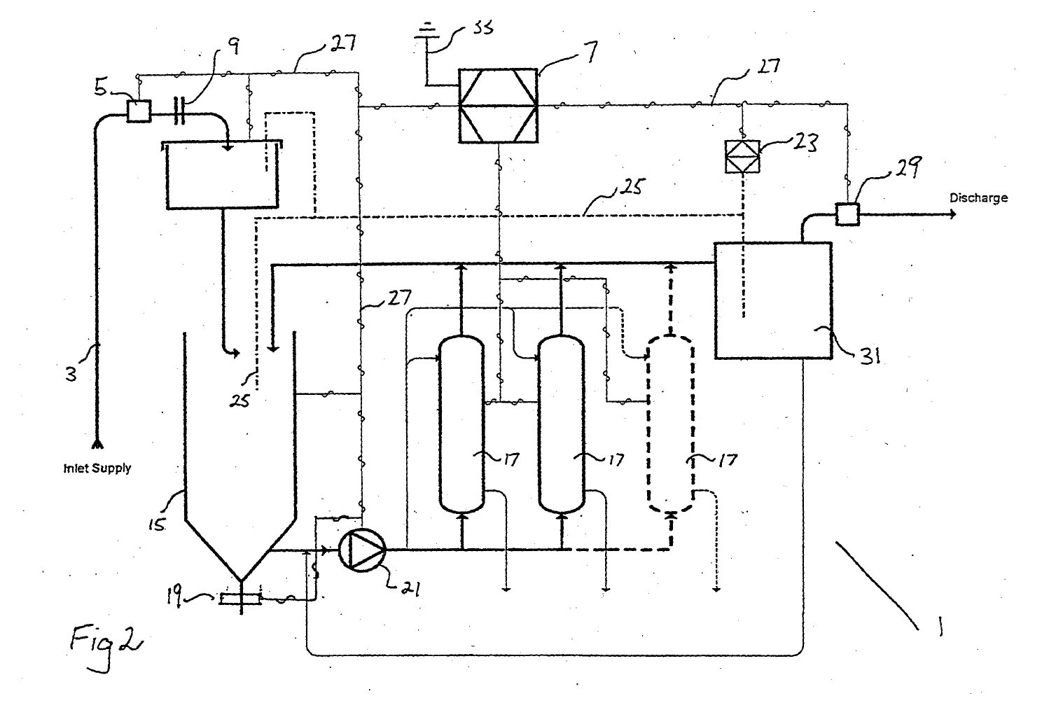

Turning to FIG. 2 we now see an alternative embodiment of the present invention wherein a second tank 31 is included. The second tank 31 acts as a temporary holding tank for the system, and holds the filtered water long enough so that the disinfectant agent can operate at maximum efficiency on the water before it is discharged via the outlet flow control means 29. The water in the second tank 31 is used to backwash or forward flush any or all the filter modules in the system. The second tank also includes sensors that control the water level in the second tank 31 to ensure that there is always sufficient water in the second tank 31 to provide the backwash or forward flushing.

Communication means 33 is included in both embodiment and enables the logic control means to send operational information of the particular water treatment facility to a central monitoring system that is operated within centralized monitoring and control facility. The central monitoring and control facility can be geographically located a substantial distance away from the water treatment facility. The central monitoring and control facility is also able to send overriding control instructions to the logic control means of the particular water treatment facility being monitored, either automatically, or via manual intervention at the central monitoring system.

Each water treatment facility has a set of operating parameters that are optimised for a water treatment facility's particular ambient conditions, such as the particular quality of the raw water feed. At the acceptable boundaries of these parameters are critical control points. The water treatment facility has a plurality of sensors associated with each of the key components of the water treatment system, and these parameters are continuously monitored. The logic control means 7 is capable of autonomously taking mitigating action if any of the data received from the sensors indicate that a particular operational parameter is trending towards a critical control point. Typical corrective action includes backwashing or forward flushing a particular component. Optionally some components within the water treatment system may include ultra-sonic means to enable embedded solids to be dislodged and removed by either a backwash or forward flushing operation.

If the autonomous corrective actions are unsuccessful in mitigating the trend of an operating parameter toward a critical control point, an alert may be generated back at the central monitoring and control facility. The facility may then either generate an automatic set of overriding control instructions, or a person at the facility can send manual instructions to the facility via the logic control means.

Both the logic control means, and the central monitoring and control facility have the capability to take the water treatment facility offline for maintenance.

In addition, the central monitoring and control means is capable of using statistical analysis techniques in combination with empirical data received from a particular water treatment facility, and thereby generate a predictive maintenance schedule for each water treatment facility under its control.

While the above description includes the preferred embodiments of the invention, it is to be understood that many variations, alterations, modifications and/or additions may be introduced into the constructions and arrangements of parts previously described without departing from the essential features or the spirit or ambit of the invention.

It wilt be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A water treatment facility for treating raw water and delivering the treated water to a plumbing network, or at least one storage tank, the system including:
logic control means,
inlet flow control means,
an inlet,
at least one flow meter,
a pre-filter,
a first tank,
first tank outflow control means,
a plurality of filter modules,
a plurality of sensors,
a disinfectant system,
outflow control means,
an outlet,
wherein the rate of flow of raw water into the facility is controlled by the inlet flow control means under the control of the logic control means, and the flow rate is measured by the flow meter and the flow rate data is fed back to the logic control means, and the raw water is then passed through the pre-filter and is then temporarily stored in the first tank that acts as a buffer tank, and sensors within the first tank feedback data via the logic control means to the inlet flow control means, so that the water level in the first tank is kept within a desired maximum and minimum level, and the water from the first tank is then delivered to the plurality of filter modules via the first tank outflow control means, under the control of the logic control means, and the plurality of filter modules are arranged so that the flow can be configured to flow through all the filter modules simultaneously, or any one or more filter modules exclusively, and the flow path through the filter module(s) can be arranged to flow through the filter modules either sequentially or in parallel, all under the control of the logic control means, and a controlled outflow from the plurality of filter modules under the control of the logic control means via the outflow control means flows out of the system through the outlet into the plumbing system that the water treatment facility is providing treated water into, and wherein the disinfectant system is capable of producing and delivering a disinfectant agent into the outflow, either within the system, or into the pipework that connects the system to the plumbing network, or the storage tank(s) that is connected to the outlet of the water treatment system on an as needed basis, under the control of the logic control means.

2. A water treatment facility as defined in claim 1 wherein a second tank is provided after the filter modules and before the outlet, and when the system is in this configuration, the disinfectant agent is delivered into the second tank, or into the outflow from the filter module(s), and the second tank acts as a temporary holding tank so that the water outflow from the filter module(s) is held long enough to enable the disinfectant agent to be effective, and after the water in the second tank has been subject to the disinfectant agent for a sufficient period of time, then a controlled outflow of water, via the logic control means through the outflow control means, is passed out of the system and into the plumbing system via the outlet.

3. A water treatment facility as defined in claim 1 wherein the inlet flow control means includes either a flow control valve, or a fixed orifice plate, or a pump, or a combination of two or more.

4. A water treatment facility as defined in claim 1 wherein the logic control means can vary the flow rate through an individual filter module in the plurality of filter modules.

5. A water treatment facility as defined in claim 1 wherein each filter module has sensor means that feedback to the logic control means, and if any module is sensed by the sensor means as operating outside acceptable operating parameters, the logic control means can take that filter module out of service and allow the facility to keep operating by using the remaining filter modules, even if the water treatment facility is required to operate with a reduced capacity.

6. A water treatment facility as defined in claim 5 wherein the logic control means can arrange the flow path through each filter module independently, or in any combination of filter modules, via a backwash feed from the second tank, so that treated water is used to forward flush, or backwash a filter module(s) as required.

7. A water treatment facility as defined in claim 1 wherein the pre-filter includes a porous belt that is continuously rotated around at least one roller as the flow of water flows laterally through the belt, and the porous belt provides the filter medium, and wherein the speed that the belt is rotated is controlled by the logic control means, and sensor means are included that measure and control the speed of the belt's rotation.

8. (canceled)

9. A water treatment facility as defined in claim 7 wherein a backwash facility is provided to the pre-filter to clean the belt, and periodic backwashing of the belt is undertaken under the control of the logic control means on an “as required” basis, and wherein the pre-filter includes disinfectant means to inhibit biological growth.

10. A water treatment facility as defined in claim 9 wherein ultrasonic vibration means are included to clean the belt, and the ultrasonic means is controlled by the logic control means, and initiated periodically on an “as required” basis.

11. (canceled)

12. A water treatment facility as defined in claim 10 wherein any waste accumulated from the belt cleaning is collected within the filter housing away from the belt, and is periodically removed.

13. A water treatment facility as defined in claim 12 wherein the pre-filter includes overflow means.

14. A water treatment facility as defined in claim 1 wherein the first tank is provided with a facility that periodically flushes away the accumulated waste that collects in the bottom of the tank via the logic control means, and the time period between flushing is sufficient to ensure that the tank is operated in a healthy and safe manner.

15. A water treatment facility as defined in claim 14 wherein the first tank provides the supply of water to the backwash facility for the pre-filter.

16. A water treatment facility as defined in claim 2 wherein the second tank provides a supply of water to backwash, or forward flush, any or all of the filter modules in the system, and the second tank maintains a minimum water level that correlates to a sufficient volume of water within the second tank to allow for the adequate backwashing or forward flushing of any or all of the filter modules under the control of the logic control means as required.

17. A water treatment facility as defined in claim 1 wherein the disinfectant agent used by the disinfectant means is ozone or uses ultra-violet radiation, and wherein the water treatment facility includes means to generate the ozone when required by the disinfectant means under the control of the logic control means.

18. (canceled)

19. (canceled)

20. A central monitoring system for at least one water treatment facility as claimed in claim 1 wherein the water treatment facility is network enabled, and a feedback stream of water treatment system operating condition data relating to each facility is fed back to the central monitoring system, and the central monitoring system includes means to optionally send control instructions back to the logic control means so that the operational parameters of each facility can be remotely controlled.

21. A central monitoring system as claimed in claim 20 wherein the water treatment facilities may be geographically dispersed over a wide area, and the central monitoring system can be a significant distance from some or all of the water treatment facilities that it monitors and controls.

22. A networked and geographically dispersed water treatment system that is centrally monitored of the type as claimed in claim 21 wherein each water treatment facility has an acceptable set of operating parameters that are optimised for the specific ambient conditions related to a particular water treatment system's specific location, including the condition of the raw water feed specific to the facility's location, and at the extremes of this set of parameters are a set of critical control points, and if the sensors detect that that the performance of the overall water treatment system, and/or any specific critical component of the water treatment system is approaching a critical control point, the logic control means can attempt to autonomously correct the situation by adjusting flow rates through components of the system, and/or changing flow paths, and/or initiating back washing, or forward flushing, or ultra-sonic cleaning operations as required to attempt to keep the system operating within allowable parameters.

23. A networked and geographically dispersed water treatment system that is centrally monitored as claimed in claim 21 wherein operating parameters of a water treatment system is also sent to the central monitoring location, creating an alert if/when any parameter approaches a critical control point, and either automatically generated or manual corrective instructions may then be sent back to the water treatment facility to attempt to correct the situation remotely, or wherein the central monitoring facility is able to use statistical analysis to determine the mean time between failure for the various components within the water treatment facility operating at a specific location, and to use that information in conjunction with other analysis techniques to create a service/maintenance schedule specific to each water treatment facility.

24. A networked and geographically dispersed water treatment system as claimed in claim 23 wherein if an operational parameter of water treatment facility continues to trend towards a critical control point, and neither the autonomous corrective actions of the logic control means, or the corrective instructions sent from the central monitoring location are able to rectify the situation, then the facility can be remotely deactivated and an alert issued to have the water treatment facility serviced.

25. (canceled)
